(19) United States
(12) Patent Application Publication
(10) Pub. No.: US 2024/0386890 A1
(43) Pub. Date: Nov. 21, 2024

(54) VOICE OPERATION DEVICE THAT OPERATES OPERATED DEVICE, COMPUTER READABLE NON-TRANSITORY RECORDING MEDIUM HAVING VOICE OPERATION PROGRAM STORED THEREIN, AND VOICE OPERATING SYSTEM

(71) Applicant: KYOCERA Document Solutions Inc., Osaka (JP)

(72) Inventor: Hiroshi NAKAMURA, Osaka (JP)

(73) Assignee: KYOCERA Document Solutions Inc., Osaka (JP)

(21) Appl. No.: 18/667,260

(22) Filed: May 17, 2024

(30) Foreign Application Priority Data
May 19, 2023 (JP) 2023-083247

(51) Int. Cl. G10L 15/22

(52) U.S. Cl. CPC G10L 15/22; G10L 2015/223

(57) ABSTRACT

A user terminal receives voice input from a user and transmits text data as a result of voice recognition performed by a voice recognition device on voice data indicating the received voice to an operated device, and the operated device operates in accordance with the text data received from the user terminal.

### INCORPORATION BY REFERENCE

This application claims priority to Japanese Patent Application No. 2023-083247 filed on May 19, 2023, the entire contents of which are incorporated by reference herein.

### BACKGROUND

The present disclosure relates to a voice operation device that operates an operated device, a computer readable non-transitory recording medium having a voice operation program stored therein, and a voice operating system.

A voice operating system including an operated system and a voice operation device that receives voice input from a user and operates an operated device is known. This voice operation device transmits voice data indicating the received voice to the operated device. The operated device executes voice recognition on the voice data transmitted from the voice operation device and operates in accordance with the result of the voice recognition.

### SUMMARY

As an aspect of the present disclosure, a technique which is a further improvement on the above technique is proposed.

According to an aspect of the present disclosure, there is provided a voice operation device that: receives voice input from a user; and transmits a result of a voice recognition process performed by a voice recognition device on voice data indicating the received voice to an operated device that operates in accordance with the result.

According to an aspect of the present disclosure, there is provided a computer readable non-transitory recording medium having a voice operation program stored therein, the program causing a computer to execute: an operation of receiving voice input from a user; and an operation of transmitting a result of voice recognition performed by a voice recognition device on voice data indicating the received voice to an operated device that operates in accordance with the result.

According to an aspect of the present disclosure, there is provided a voice operating system including: an operated device; and a voice operation device that receives voice input from a user and operates the operated device, wherein the voice operation device transmits a result of voice recognition performed by a voice recognition device on voice data indicating the received voice to the operated device, and the operated device operates in accordance with the result.

### BRIEF DESCRIPTION OF THE DRAWINGS

FIG. 1 is a block diagram of a voice operating system according to an embodiment of the present disclosure.

FIG. 2 is a block diagram of a user terminal shown in FIG. 1.

FIG. 3 is a block diagram of a voice recognition device shown in FIG. 1 when constituted by one computer.

FIG. 4 is a block diagram of an operated device shown in FIG. 1 in the case of an MFP.

FIG. 5 is a sequence diagram of the operation of the voice operating system shown in FIG. 1 in a case where connection between the user terminal and the operated device is established.

FIG. 6 is a sequence diagram of the operation of the voice operating system shown in FIG. 1 in a case where the operated device is operated through the user terminal.

FIG. 7 is a flowchart of the operation of the user terminal shown in FIG. 1 in a case where text data is received from the voice recognition device.

### DETAILED DESCRIPTION

Hereinafter, a voice operation device, a voice operation program, a computer readable non-transitory recording medium having the voice operation program stored therein, and a voice operating system according to an embodiment will be described with reference to the accompanying drawings as an aspect of the present disclosure.

First, the configuration of a voice operating system according to an embodiment of the present disclosure will be described.

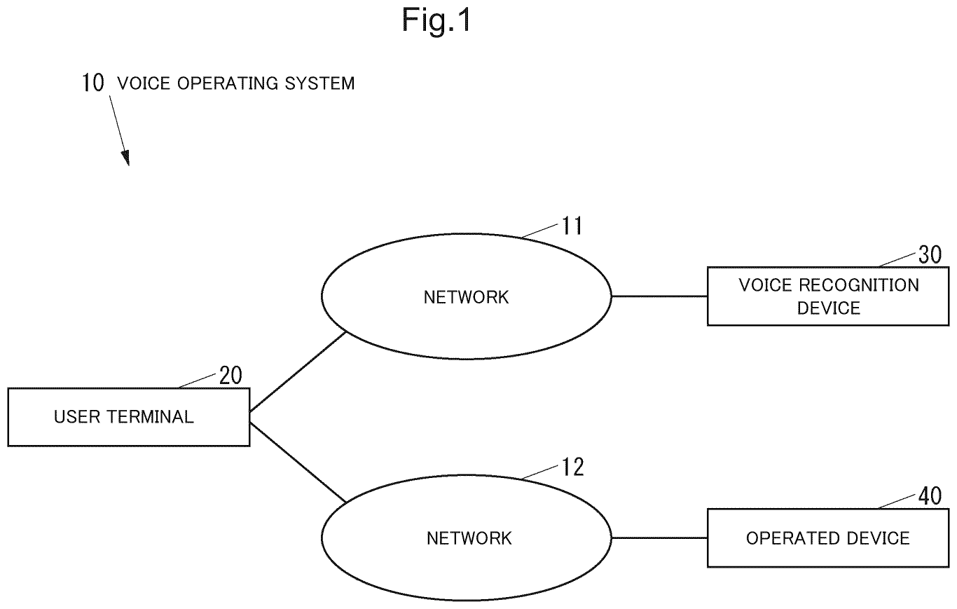

FIG. 1 is a block diagram of a voice operating system 10 according to the present embodiment. As shown in FIG. 1, the voice operating system 10 includes a user terminal 20 serving as a voice operation device that receives voice input from a user and operates an operated device. The user terminal 20 receives voice from the user and generates voice data indicating the received voice. The user terminal 20 is constituted by an information processing device such as, for example, a smartphone or a tablet terminal.

The voice operating system 10 includes a voice recognition device 30 that executes a voice recognition process on voice data generated by the user terminal 20 and converts the voice data into text data through the voice recognition process. The voice recognition device 30 may be constituted by one information processing device, or may be constituted by a plurality of information processing devices. For example, as the voice recognition device 30, a voice recognition device trained on the voice of the user of the user terminal 20 may be adopted. In this case, the voice recognition device 30 executes voice recognition corresponding to the voice quality, accent, and speaking habits of the user of the user terminal 20.

The voice operating system 10 includes an operated device 40 that operates in accordance with the operation content indicated by the text data input from the user terminal 20. The operated device 40 is, for example, a multifunction peripheral (MFP).

That is, the voice operating system 10 includes the user terminal 20, the voice recognition device 30, and the operated device 40. However, a system that does not include the voice recognition device 30 but includes the user terminal 20 and the operated device 40 is also an embodiment of the voice operating system 10.

In the voice operating system 10, the user terminal 20 and the voice recognition device 30 can communicate with each other through a network 11 such as, for example, a local area network (LAN) or the Internet.

In the voice operating system 10, the user terminal 20 and the operated device 40 can communicate with each other through a network 12 such as, for example, a LAN or the Internet.

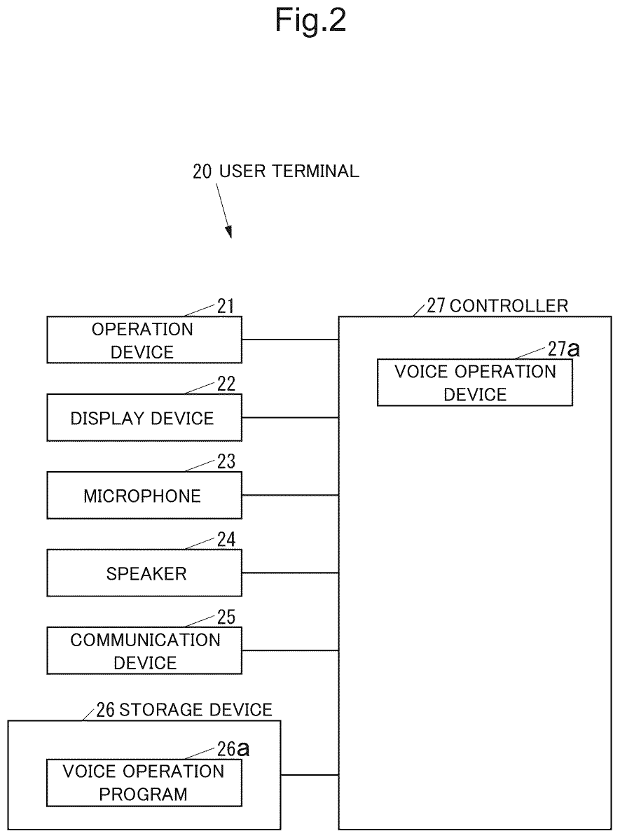

FIG. 2 is a block diagram of the user terminal 20. As shown in FIG. 2, the user terminal 20 includes an operation device 21 which is an operation device such as, for example, a button for inputting various types of operations, a display device 22 which is a display device such as, for example, a liquid crystal display (LCD) that displays various types of information, a microphone 23, a speaker 24, a communication device 25 which is a communication device that communicates with an external device through a network such as a LAN or the Internet, or directly by wire or wirelessly without going through a network, a storage device 26 which is a non-volatile storage device such as, for example, a semiconductor memory or a hard disk drive (HDD) that stores various types of information, and a controller 27 that controls the operation of the entirety of the user terminal 20. The microphone 23 is an example of a voice receiver in the claims.

The storage device 26 stores a voice operation program 26a for receiving voice input from a user and operating the operated device. The voice operation program 26a, for example, may be installed in the user terminal 20 at the manufacturing stage of the user terminal 20, may be additionally installed in the user terminal 20 from an external storage medium such as a Universal Serial Bus (USB) memory, or may be additionally installed in the user terminal 20 from a network.

The controller 27 is provided with, for example, a microprocessor including a central processing unit (CPU) or the like serving as a computer, a read only memory (ROM) that stores programs and various types of data, and a random access memory (RAM) serving as a memory used as a work area of the CPU of the controller 27. The CPU of the controller 27 executes a program stored in the storage device 26 or the ROM of the controller 27. The controller 27 is an example of a first controller in the claims.

The controller 27 executes the voice operation program 26a to thereby operate as a voice operation device 27a that receives voice input from a user and operates the operated device.

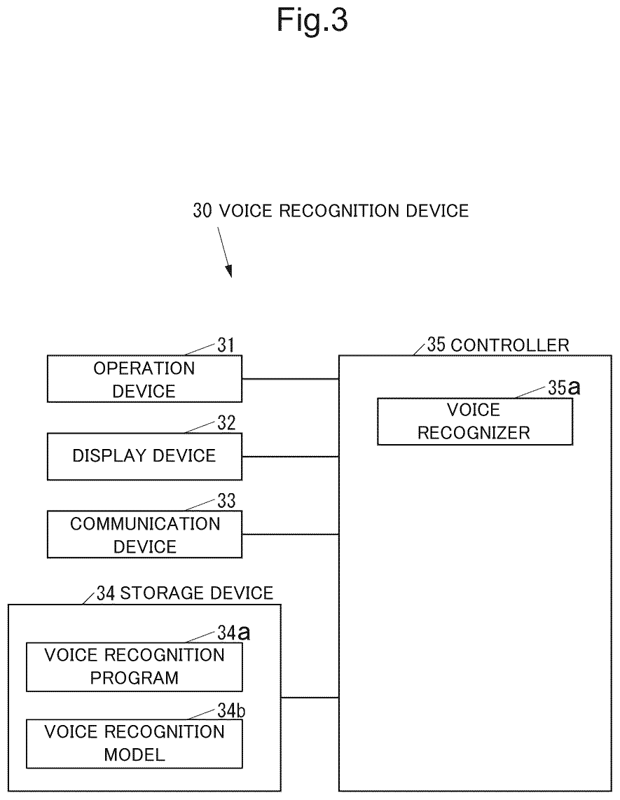

FIG. 3 is a block diagram of the voice recognition device 30 when constituted by one computer.

As shown in FIG. 3, the voice recognition device 30 includes an operation device 31 which is an operation device such as, for example, a keyboard or a mouse through which various types of operations are input, a display device 32 which is a display device such as, for example, an LCD that displays various types of information, a communication device 33 which is a communication device that communicates with an external device through a network such as a LAN or the Internet, or directly by wire or wirelessly without going through a network, a storage device 34 which is a non-volatile storage device such as, for example, a semiconductor memory or an HDD that stores various types of information, and a controller 35 that controls the operation of the entirety of the voice recognition device 30.

The storage device 34 stores a voice recognition program 34a for converting voice data generated by the user terminal 20 into text data through voice recognition. The voice recognition program 34a, for example, may be installed in the voice recognition device 30 at the manufacturing stage of the voice recognition device 30, may be additionally installed in the voice recognition device 30 from an external storage medium such as a USB memory, or may be additionally installed in the voice recognition device 30 from a network.

Further, the storage device 34 stores a voice recognition model 34b which is a machine learning model for converting voice data into text data through voice recognition.

The controller 35 is provided with, for example, a microprocessor including a CPU or the like serving as a computer, a CPU, a ROM that stores programs and various types of data, and a RAM serving as a memory used as a work area of the CPU of the controller 35. The CPU of the controller 35 executes a program stored in the storage device 34 or the ROM of the controller 35.

The controller 35 executes the voice recognition program 34a to thereby operate as a voice recognizer 35a that converts voice data generated by the user terminal 20 into text data through voice recognition.

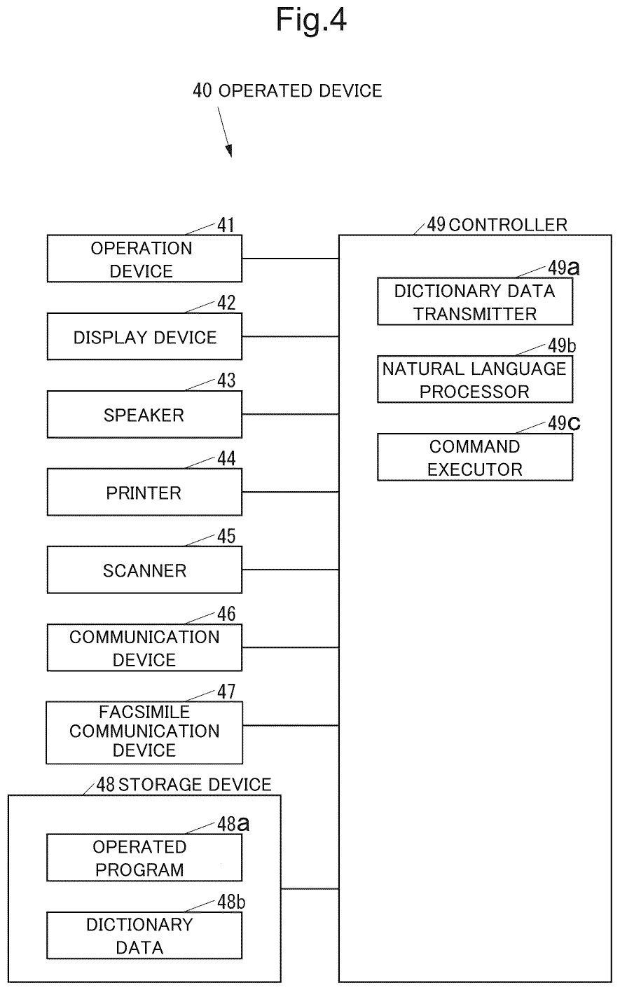

FIG. 4 is a block diagram of the operated device 40 in the case of an MFP.

As shown in FIG. 4, the operated device 40 includes an operation device 41 which is an operation device such as, for example, a button for inputting various types of operations, a display device 42 which is a display device such as, for example, an LCD that displays various types of information, a speaker 43, a printer 44 which is a printing device that prints an image on a recording medium such as paper, a scanner 45 which is a reading device that reads an image from a manuscript, a communication device 46 which is a communication device that communicates with an external device through a network such as a LAN or the Internet, or directly by wire or wirelessly without going through a network, a facsimile communication device 47 which is a facsimile device that performs facsimile communication with an external facsimile machine (not shown) through a communication line such as a public telephone line, a storage device 48 which is a non-volatile storage device such as, for example, a semiconductor memory or an HDD that stores various types of information, and a controller 49 that controls the operation of the entirety of the operated device 40.

The storage device 48 stores an operated program 48a for operating in accordance with the operation content indicated by the text data input from the user terminal 20. The operated program 48a, for example, may be installed in the operated device 40 at the manufacturing stage of the operated device 40, may be additionally installed in the operated device 40 from an external storage medium such as a USB memory, or may be additionally installed in the operated device 40 from a network.

The storage device 48 stores dictionary data 48b indicating specialized terminology specific to the operated device 40.

The controller 49 is provided with, for example, a microprocessor including a CPU or the like serving as a computer, a ROM that stores programs and various types of data, and a RAM serving as a memory used as a work area of the CPU of the controller 49. The CPU of the controller 49 executes a program stored in the storage device 48 or the ROM of the controller 49. The controller 49 is an example of a second controller in the claims.

The controller 49 executes the operated program 48a to thereby operate as a dictionary data transmitter 49a that transmits dictionary data indicating specialized terminology specific to the operated device 40 to the user terminal 20, a natural language processor 49b that converts the text data input from the user terminal 20 into a command for the operated device 40 through a natural language process, and a command executor 49c that operates in accordance with the command generated by the natural language processor 49b.

Next, the operation of the voice operating system 10 will be described.

First, the operation of the voice operating system 10 in a case where connection between the user terminal 20 and the operated device 40 is established will be described.

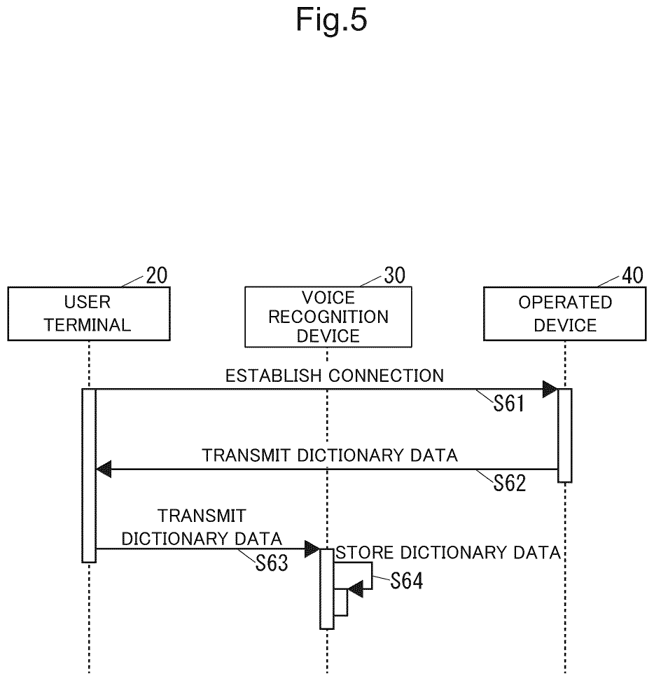

FIG. 5 is a sequence diagram of the operation of the voice operating system 10 when connection between the user terminal 20 and the operated device 40 is established.

A user inputs a connection establishment instruction to establish connection between the user terminal 20 and the operated device 40 to the user terminal 20 through the operation device 21 of the user terminal 20.

When the above connection establishment instruction is received by the operation device 21, the voice operation device 27a of the user terminal 20 establishes connection with the operated device 40 using the communication device 25 (S61).

When the connection with the user terminal 20 is established in S61, the dictionary data transmitter 49a of the operated device 40 transmits the same dictionary data as the dictionary data 48b from the communication device 46 to the user terminal 20 (S62).

When the dictionary data transmitted from the operated device 40 in S62 is received through the communication device 25, the voice operation device 27a of the user terminal 20 transmits the received dictionary data to the voice recognition device 30 from the communication device 25 (S63).

When the dictionary data transmitted from the user terminal 20 in S63 is received by the communication device 33, the voice recognizer 35a of the voice recognition device 30 stores the received dictionary data in the storage device 34 or the RAM of the controller 35 (S64).

Next, the operation of the voice operating system 10 when the operated device 40 is operated through the user terminal 20 will be described.

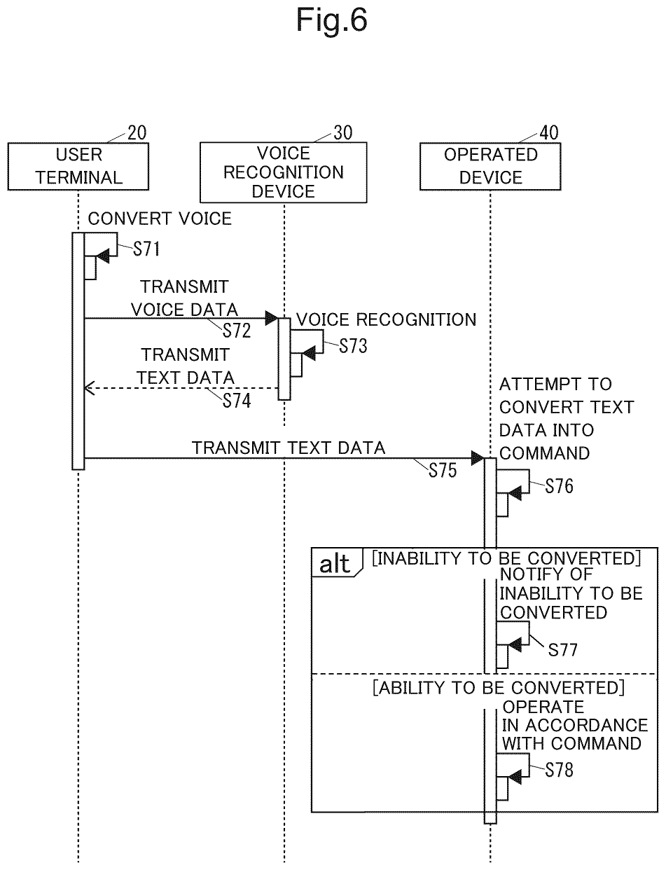

FIG. 6 is a sequence diagram of the operation of the voice operating system 10 when the operated device 40 is operated through the user terminal 20.

When the connection between the user terminal 20 and the operated device 40 is established, the user inputs a voice indicating the operation content for the operated device 40 such as, for example, “copy” into the microphone 23 of the user terminal 20.

When the above voice is input to the microphone 23, the voice operation device 27a of the user terminal 20 converts the voice input to the microphone 23 into voice data (S71).

After the conversion in S71, the voice operation device 27a transmits the converted voice data from the communication device 25 to the voice recognition device 30 (S72).

When the voice data transmitted from the user terminal 20 in S72 is received by the communication device 33, the voice recognizer 35a of the voice recognition device 30 converts the received voice data into text data by performing voice recognition on the received voice data using the voice recognition model 34b (S73). When the voice recognizer 35a performs voice recognition using the voice recognition model 34b, the voice recognition is performed using the dictionary data stored in the storage device 34 or the RAM of the controller 35 in S64. The dictionary data stores a plurality of commands (which will be described above) for bringing the operated device 40 into operation, and each of the plurality of commands is configured to include a word (specialized terminology specific to the operated device 40). This word is, for example, “copy,” “scan,” or the like. When the voice recognizer 35a performs voice recognition using the voice recognition model 34b and the dictionary data, text data indicating text consisting of, for example, “Make a copy” as a sentence containing the word, for example, “copy” may in some cases be extracted and generated, and text data indicating text such as, for example, “Do not copy” may in other cases be extracted and generated.

When the process of S73 is completed, the voice recognizer 35a transmits the text data generated in S73 from the communication device 33 to the user terminal 20 (S74).

When the text data transmitted from the voice recognition device 30 in S74 is received by the communication device 25, the voice operation device 27a of the user terminal 20 transmits the received text data to the operated device 40 from the communication device 25 (S75).

When the text data transmitted from the user terminal 20 in S75 is received by the communication device 46, the natural language processor 49b of the operated device 40 performs a conversion process of converting the received text data into a command for the operated device 40 through a natural language process (S76).

In a case where the text data cannot be converted into a command in S76 through the above conversion process, the natural language processor 49b of the operated device 40 performs a notification process of notifying a user of a message that the text data could not be converted into a command (S77). As the above conversion process, the natural language processor 49b determines whether the text data transmitted from the user terminal 20 matches text determined in advance as a command (text such as “make a copy” or “make a scan”). In the case of matching, the natural language processor determines that the text data can be converted into a command, and in the case of not matching, it determines that the text data cannot be converted into a command. The natural language processor 49b performs at least one of causing the display device 42 to display the above message or causing the speaker 43 to utter the above message as the above notification process. In a case where the speaker 43 is caused to utter the above message, the natural language processor 49b causes the speaker 43 to output a voice corresponding to text indicated by the text data transmitted from the user terminal 20 in S75. For example, the natural language processor 49b causes the speaker 43 to output, for example, “Do not copy” as text indicated by the text data transmitted from the user terminal 20 in S75, the text not being able to be converted into a command.

In a case where the natural language processor 49b determines that the text data transmitted from the user terminal 20 matches text determined in advance as a command, that is, the text data can be converted into a command in S76, the command executor 49c of the operated device 40 performs operation control according to the command generated by the conversion (S78). For example, in a case where the text data transmitted from the user terminal 20 in S75 matches the text “Make a copy” determined in advance as a copy operation execution command, and the text data can be converted into the copy operation execution command, the command executor 49c causes the operated device 40 to perform an operation for causing the scanner 45 to read an image from a manuscript and causing the printer 44 to print the image read from the manuscript by the scanner 45 onto a recording medium, in accordance with the copy operation execution command.

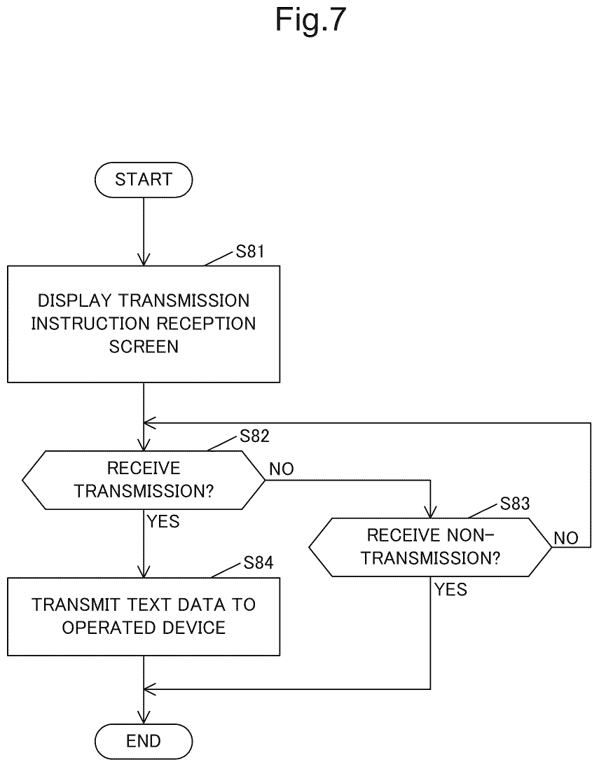

Meanwhile, in the example shown in FIG. 6, in a case where the text data transmitted from the voice recognition device 30 is received, the voice operation device 27a of the user terminal 20 always transmits the text data received from the voice recognition device 30 to the operated device 40 (S75). However, in a case where the text data transmitted from the voice recognition device 30 is received, the voice operation device 27a may transmit the text data received from the voice recognition device 30 to the operated device 40 only when there is an instruction from the user as shown in the following FIG. 7.

FIG. 7 is a flowchart illustrating the operation of the user terminal 20 in a case where text data is received from the voice recognition device 30.

The voice operation device 27a of the user terminal 20 executes the operation shown in FIG. 7 in a case where the text data transmitted from the voice recognition device 30 is received by the communication device 25.

As shown in FIG. 7, the voice operation device 27a causes the display device 21 of the user terminal 20 to display a transmission instruction reception screen for receiving an instruction on whether to transmit the text data received by the communication device 25 from the voice recognition device 30 to the operated device 40 through the operation device 21 of the user terminal 20 (S81). The content of the text data and the like received from the voice recognition device 30 are displayed on the transmission instruction reception screen. When the transmission instruction reception screen is displayed on the display device 21, the voice operation device 27a may cause the speaker 24 to utter the content of the text data received from the voice recognition device 30 together with this display or instead of this display. In a case where the content of the text data received from the voice recognition device 30 is notified through the speaker 24, the voice operation device 27a causes the speaker 24 to output a voice corresponding to text indicated by the text data received from the voice recognition device 30. For example, the voice operation device 27a causes the speaker 43 to output a voice corresponding to text indicated by the text data received from the voice recognition device 30, for example, “Do not copy” which is not the text determined in advance, or “Make a copy” which is the text determined in advance.

When the process of S81 is completed, the voice operation device 27a determines whether a transmission instruction to transmit the text data received from the voice recognition device 30 to the operated device 40 has been received by the operation device 21 (S82).

When it is determined that the above transmission instruction has not been received by the operation device 21 (NO in S82), the voice operation device 27a determines whether a non-transmission instruction not to transmit the text data received from the voice recognition device 30 to the operated device 40 has been received by the operation device 21 (S83).

In a case where the voice operation device 27a determines that the non-transmission instruction has not been received by the operation device 21 (NO in S83), the process returns to S82.

On the other hand, when it is determined that the above transmission instruction has been received by the operation device 21 (YES in S82), the voice operation device 27a transmits the text data received from the voice recognition device 30 to the operated device 40 (S84). Thereafter, the operation shown in FIG. 7 ends.

In addition, when it is determined that the above non-transmission instruction has been received by the operation device 21 (YES in S83), the voice operation device 27a does not transmit the text data received from the voice recognition device 30 to the operated device 40. Thereafter, the operation shown in FIG. 7 ends.

As described above, the user terminal 20 causes the voice recognition device 30 separate from the operated device 40 to execute voice recognition on voice data indicating a voice input from the user (S73), and thus it is possible to adopt a device that does not have a configuration for executing a voice recognition function as the operated device 40. It is possible to adopt a device with high accuracy of voice recognition for the user's voice as the voice recognition device 30, and as a result, it is possible to improve the possibility that the operated device 40 will operate as intended by the user.

Since the user terminal 20 can improve the possibility that the operated device 40 will operate as intended by the user, it is possible to reduce the need for the user to redo the utterance, and as a result, it is possible to improve convenience.

Since the text data converted from the user's voice data is transmitted to the operated device 40 without transmitting the voice data to the operated device 40, the user terminal 20 does not have to utter words corresponding to commands in the vicinity of the operated device 40, and thus it is possible to protect the user's privacy.

The user terminal 20 downloads dictionary data indicating specialized terminology specific to the operated device 40 from the operated device 40 (S62), and passes the downloaded dictionary data to the voice recognition device 30 (S63). Therefore, even if the voice recognition device 30 does not hold the dictionary data indicating specialized terminology specific to the operated device 40 in advance, it is possible to cause the voice recognition device 30 to execute high-accuracy voice recognition (S73) using the dictionary data indicating specialized terminology specific to the operated device 40, and as a result, it is possible to improve the possibility that the operated device 40 will operate as intended by the user.

In a general voice operating system which is not based on the present embodiment, there is a problem in that the accuracy of voice recognition is likely to be low, and as a result, the possibility of the operated device operating as intended by the user may be low.

On the other hand, in the present embodiment, it is possible to improve the possibility that the operated device will operate as intended by the user.

Meanwhile, in a case where voice data is converted into text data, the voice recognition device 30 may perform a process of converting the voice data into text data without using dictionary data indicating specialized terminology specific to the operated device 40. In a case where the voice recognition device 30 does not use the dictionary data indicating the specialized terminology specific to the operated device 40, the voice operating system 10 does not download the dictionary data indicating the specialized terminology specific to the operated device 40 to the voice recognition device 30.

The voice operating system 10 includes the voice recognition device 30 separately from the user terminal 20 in the present embodiment. However, the user terminal 20 may also serve as the voice recognition device 30.

While the present disclosure has been described in detail with reference to the embodiments thereof, it would be apparent to those skilled in the art that the various changes and modifications may be made therein within the scope defined by the appended claims.

What is claimed is:

1. A voice operation device that:
receives voice input from a user; and
transmits a result of a voice recognition process performed by a voice recognition device on voice data indicating the received voice to an operated device that operates in accordance with the result.

2. The voice operation device according to claim 1, wherein dictionary data indicating specialized terminology specific to the operated device is downloaded from the operated device and transmitted the downloaded dictionary data to the voice recognition device that executes the voice recognition process using the downloaded dictionary data.

3. A computer readable non-transitory recording medium having a voice operation program stored therein, the program causing a computer to execute:
an operation of receiving voice input from a user; and
an operation of transmitting a result of voice recognition performed by a voice recognition device on voice data indicating the received voice to an operated device that operates in accordance with the result.

4. A voice operating system comprising:
an operated device; and
a voice operation device that receives voice input from a user and operates the operated device,
wherein the voice operation device transmits a result of voice recognition performed by a voice recognition device on voice data indicating the received voice to the operated device, and
the operated device operates in accordance with the result.

5. The voice operating system according to claim 4, wherein the voice operation device includes a voice receiver that receives voice input from a user,
a first communication device that communicates with the operated device and the voice recognition device, and
a first controller that includes a processor and causes the processor to execute a computer program to transmit voice data indicating the voice received by the voice receiver and dictionary data indicating specialized terminology specific to the operated device received from the operated device by the first communication device by the first communication device to the voice recognition device,
the first controller transmits text data indicating text generated through a voice recognition process using the dictionary data in the voice recognition device from the first communication device to the operated device, and
the operated device includes a second communication device that communicates with the voice operation device,
a storage device that stores the dictionary data, and
a second controller that includes a processor and causes the processor to execute an operated program to operate as
a dictionary data transmitter that transmits the dictionary data from the second communication device to the voice operation device,
a natural language processor that generates a command from the text data when the second communication device receives the text data from the voice operation device, and
a command executor that brings the operated device into operation in accordance with the command generated by the natural language processor.
